(19) United States
(12) Patent Application Publication
(10) Pub. No.: US 2026/0363351 A1
(43) Pub. Date: Nov. 19, 2026

(54) AEROSOL PROVISION DEVICE

(71) Applicant: NICOVENTURES TRADING LIMITED, London (GB)

(72) Inventors: Peter DAVIS, London (GB); Pablo UCCELLATORE, London (GB); Nicholas WALPOLE, London (GB); Gilbert AYINA, London (GB)

(21) Appl. No.: 19/752,420

(22) Filed: Jul. 23, 2026

Related U.S. Application Data
(63) Continuation of application No. 19/107,660, filed on Aug. 25, 2023.

(30) Foreign Application Priority Data
Sep. 2, 2022 (GB) 2212819.3

(51) Int. Cl. A24F 40/57; A24F 40/465; H05B 6/10

(52) U.S. Cl. CPC A24F 40/57; A24F 40/465; H05B 6/108

(57) ABSTRACT

An aerosol provision device configured to receive at least a portion of an article including aerosol generating material, the aerosol provision device including: a first heating unit arranged to heat the aerosol generating material to form aerosol in use; a second heating unit arranged to heat the aerosol generating material to form aerosol in use; and a controller configured to control the first and second heating units during an aerosol generation session according to a heating mode, wherein during the heating mode the controller is configured to: control the first heating unit to begin heating to a first target operating temperature T1 at the beginning of the session; control the second heating unit to begin heating to a second target operating temperature T2 at a time t1 after the start of the aerosol generation session, wherein t1>85 seconds.

### RELATED APPLICATIONS

The present application is a continuation of U.S. patent application Ser. No. 19/107,660, filed Feb. 28, 2025, which is a National Phase entry of PCT Application No. PCT/EP2023/073447 filed Aug. 25, 2023, which claims priority to GB Application No. 2212819.3 filed Sep. 2, 2022, each of which is hereby incorporated by reference in their entirety.

### TECHNICAL FIELD

The present invention relates to an aerosol provision device, an aerosol provision system and an article.

### BACKGROUND

Smoking articles such as cigarettes, cigars and the like burn tobacco during use to create tobacco smoke. Attempts have been made to provide alternatives to these articles that burn tobacco by creating products that release compounds without burning. Examples of such products are heating devices which release compounds by heating, but not burning, the material. The material may be for example tobacco or other non-tobacco products, which may or may not contain nicotine.

### SUMMARY

In accordance with some embodiments described herein, there is provided an aerosol provision device configured to receive at least a portion of an article comprising aerosol generating material, the aerosol provision device comprising: a first heating unit arranged to heat the aerosol generating material to form aerosol in use; a second heating unit arranged to heat the aerosol generating material to form aerosol in use; and a controller configured to control the first and second heating units during an aerosol generation session according to a heating mode, wherein during the heating mode the controller is configured to: control the first heating unit to begin heating to a first target operating temperature T1 at the beginning of the session; control the second heating unit to begin heating to a second target operating temperature T2 at a time t1 after the start of the aerosol generation session, wherein t1>85 seconds.

T2 may be less than 160 deg C. T2 may be substantially 150 deg C.

During the heating mode the controller may be configured to control the second heating unit to heat to a third target operating temperature T4 at time t3 after the start of the aerosol generation session, wherein t3>t1 and T4>T2.

During the heating mode the controller may be configured to control the second heating unit to reduce its temperature to a second heating unit step-down temperature T3 at time t2 after the start of the aerosol generation session.

t2 may be less than t1.

T3 may be greater than T2.

T3 may be less than 220 deg C. T3 may be less than 210 deg C. T3 may be substantially 200 deg C.

During the heating mode the controller may be configured to control the second heating unit to reduce its temperature to the second heating unit step-down temperature T3 more than 30 seconds before the end of the aerosol generation session.

During the heating mode the controller may be configured to control the second heating unit to reduce its temperature to a second heating unit step-down temperature T3 substantially 35 seconds before the end of the aerosol generation session.

During the heating mode the controller is configured to control the first heating unit to reduce its temperature to a first heating unit step-down temperature T5 at time t4 after the start of the aerosol generation session, wherein T5 is less than T1.

T3 may be less than or equal to T5. T3 may be equal to T5.

t4 may be greater than t2. t4 may be less than t3.

During the heating mode the controller is configured to: control the first heating unit to heat to a first unit maximum operating temperature during the aerosol generation session; and control the second heating unit to heat to a second unit maximum operating temperature during the aerosol generation session, wherein the first unit maximum operating temperature is greater than the second unit maximum operating temperature.

T1 may be the first unit maximum operating temperature. T1 and/or the first unit maximum operating temperature may be less than 260 deg C. T1 and/or the first unit maximum operating temperature may be less than 250 deg C. T1 and/or the first unit maximum operating temperature may be substantially 240 deg C.

T4 may be the second unit maximum operating temperature. T4 and/or the second unit maximum operating temperature may be less than 240 deg C. T4 and/or the second unit maximum operating temperature may be less than 230 deg C. T4 and/or the second unit maximum operating temperature may be substantially 220 deg C.

The first heating unit and the second heating unit may be configured to heat different portions of the aerosol generating material.

The first heating unit and the second heating unit may be spatially separated.

The aerosol provision device may have a mouth end, wherein the first heating unit may be arranged closer to the mouth end than the second heating unit.

The first heating unit may comprise a first induction heating unit. The second heating unit may comprise a second induction heating unit.

During the heating mode the controller may be configured to control the second heating unit not to heat until the time t1.

The heating mode may be a base heating mode and the controller further configured to heat according to a boost heating mode, wherein in the boost heating mode the device is configured to generate aerosol at a higher rate for a shorter duration than in the base heating mode.

t1 may be greater than 90 seconds t1 may be greater than 95 seconds. t1 may be substantially 100 s.

The aerosol generating material may be a non-liquid aerosol generating material. The aerosol generating material may comprise tobacco. The aerosol generating device may be a tobacco heating product.

In accordance with some embodiments described herein, there is provided an aerosol provision system comprising the aerosol provision device as described above and the article.

In accordance with some embodiments described herein, there is provided method of controlling an aerosol provision device according to a heating mode, the aerosol provision device configured to receive at least a portion of an article comprising aerosol generating material, the method comprising: controlling a first heating unit of the aerosol provision device to begin heating to a first target operating temperature T1 at the beginning of an aerosol generation session; and controlling a second heating unit of the aerosol provision device to begin heating to a second target operating temperature T2 at a time t1 after the start of the aerosol generation session, wherein t1>85 seconds.

The aerosol provision system may comprise any of the features of the aerosol provision device described above. The method may comprise any of the functional steps described with respect to the aerosol provision device.

### BRIEF DESCRIPTION OF THE DRAWINGS

Embodiments will now be described, by way of example only, and with reference to the accompanying drawings in which:

FIG. 1A is a schematic diagram of a heating assembly of an aerosol generation device;

FIG. 1B is a cross-sectional view of the heating assembly with an aerosol generating article disposed therein;

FIG. 2A is a schematic cross-sectional view of the aerosol generating article;

FIG. 2B is a perspective view of the aerosol generating article;

FIG. 3 is a graph showing temperature profiles of a first heating mode; and

FIG. 4 is a graph showing temperature profiles of a second heating mode.

### DETAILED DESCRIPTION

As used herein, “the” may be used to mean “the” or “the or each” as appropriate. In particular, features described in relation to “the at least one heating unit” may be applicable to the first, second or further heating units where present. Further, features described in respect of a “first” or “second” integers may be equally applicable integers. For example, features described in respect of a “first” or “second” heating unit may be equally applicable to the other heating units in different embodiments. Similarly, features described in respect of a “first” or “second” mode of operation may be equally applicable to other configured modes of operation.

In general, reference to a “first” heating unit in the heating assembly does not indicate that the heating assembly contains more than one heating unit, unless otherwise specified; rather, the heating assembly comprising a “first” heating unit must simply comprise at least one heating unit. Accordingly, a heating assembly containing only one heating unit expressly falls within the definition of a heating assembly comprising a “first” heating unit.

Similarly, reference to a “first” and “second” heating unit in the heating assembly does not necessarily indicate that the heating assembly contains two heating units only; further heating units may be present. Rather, in this example, the heating assembly must simply comprise at least a first and a second heating unit.

Where reference is made to an event such as reaching a maximum operating temperature occurring “within” a given period, the event may occur at any time between the beginning and the end of the period.

As used herein, the term “aerosol-generating material” includes materials that provide volatilized components upon heating, typically in the form of an aerosol. Aerosol-generating material includes any tobacco-containing material and may, for example, include one or more of tobacco, tobacco derivatives, expanded tobacco, reconstituted tobacco or tobacco substitutes. Aerosol-generating material also may include other, non-tobacco, products, which, depending on the product, may or may not contain nicotine. Aerosol-generating material may for example be in the form of a solid, a liquid, a gel, a wax or the like. Aerosol-generating material may for example also be a combination or a blend of materials. Aerosol-generating material may also be known as “smokable material”. In a preferred embodiment, the aerosol-generating material is a non-liquid aerosol-generating material. In a particularly preferred embodiment, the non-liquid aerosol-generating material comprises tobacco.

Aerosol-generating material is a material that is capable of generating aerosol, for example when heated, irradiated or energized in any other way. Aerosol-generating material may, for example, be in the form of a solid, liquid or gel which may or may not contain an active substance and/or flavorants. In some embodiments, the aerosol-generating material may comprise an “amorphous solid”, which may alternatively be referred to as a “monolithic solid” (i.e. non-fibrous). In some embodiments, the amorphous solid may be a dried gel. The amorphous solid is a solid material that may retain some fluid, such as liquid, within it. In some embodiments, the aerosol-generating material may for example comprise from about 50 wt %, 60 wt % or 70 wt % of amorphous solid, to about 90 wt %, 95 wt % or 100 wt % of amorphous solid.

The aerosol-generating material may comprise one or more active substances and/or flavors, one or more aerosol-former materials, and optionally one or more other functional material.

Apparatus is known that heats aerosol-generating material to volatilize at least one component of the aerosol-generating material, typically to form an aerosol which can be inhaled, without burning or combusting the aerosol-generating material. Such apparatus is sometimes described as an “aerosol-generating device”, an “aerosol provision device”, a “heat-not-burn device”, a “tobacco heating product”, a “tobacco heating product device”, a “tobacco heating device” or similar. In a preferred embodiment of the present invention, the aerosol-generating device of the present invention is a tobacco heating product. The non-liquid aerosol-generating material for use with a tobacco heating product comprises tobacco.

Similarly, there are also so-called e-cigarette devices, which are typically aerosol-generating devices which vaporize an aerosol-generating material in the form of a liquid, which may or may not contain nicotine. The aerosol-generating material may be in the form of or be provided as part of a rod, cartridge or cassette or the like which can be inserted into the apparatus. A heater for heating and volatilizing the aerosol-generating material may be provided as a “permanent” part of the apparatus.

An aerosol-generating device can receive an article comprising aerosol-generating material for heating, also referred to as a “smoking article”. An “article”, “aerosol-generating article” or “smoking article” in this context is a component that includes or contains in use the aerosol-generating material, which is heated to volatilize the aerosol-generating material, and optionally other components in use. A user may insert the article into the aerosol-generating device before it is heated to produce an aerosol, which the user subsequently inhales. The article may be, for example, of a predetermined or specific size that is configured to be placed within a heating chamber of the device which is sized to receive the article.

The aerosol-generating device according to a preferred embodiment of the present invention comprises a plurality of heating units, each heating unit being arranged to heat, but not burn, the aerosol-generating material in use.

A heating unit typically refers to a component which is arranged to receive electrical energy from an electrical energy source, and to supply thermal energy to an aerosol-generating material. A heating unit comprises a heating element. A heating element is typically a material which is arranged to supply heat to an aerosol-generating material in use. The heating unit comprising the heating element may comprise any other component required, such as a component for transducing the electrical energy received by the heating unit. In other examples, the heating element itself may be configured to transduce electrical energy to thermal energy.

The heating unit may comprise a coil. In some examples, the coil is configured to, in use, cause heating of at least one electrically-conductive heating element, so that heat energy is conductible from the at least one electrically-conductive heating element to aerosol generating material to thereby cause heating of the aerosol generating material.

In some examples, the coil is configured to generate, in use, a varying magnetic field for penetrating at least one heating element, to thereby cause induction heating and/or magnetic hysteresis heating of the at least one heating element. In such an arrangement, the or each heating element may be termed a “susceptor”. A coil that is configured to generate, in use, a varying magnetic field for penetrating at least one electrically-conductive heating element, to thereby cause induction heating of the at least one electrically-conductive heating element, may be termed an “induction coil” or “inductor coil”.

The device may include the heating element(s), for example electrically-conductive heating element(s), and the heating element(s) may be suitably located or locatable relative to the coil to enable such heating of the heating element(s). The heating element(s) may be in a fixed position relative to the coil. Alternatively, the at least one heating element, for example at least one electrically-conductive heating element, may be included in an article for insertion into a heating zone of the device, wherein the article also comprises the aerosol generating material and is removable from the heating zone after use. Alternatively, both the device and such an article may comprise at least one respective heating element, for example at least one electrically-conductive heating element, and the coil may be to cause heating of the heating element(s) of each of the device and the article when the article is in the heating zone.

In some examples, the coil is helical. In some examples, the coil encircles at least a part of a heating zone of the device that is configured to receive aerosol generating material. In some examples, the coil is a helical coil that encircles at least a part of the heating zone.

In some examples, the device comprises an electrically-conductive heating element that at least partially surrounds the heating zone, and the coil is a helical coil that encircles at least a part of the electrically-conductive heating element. In some examples, the electrically-conductive heating element is tubular. In some examples, the coil is an inductor coil.

In some examples, the heating unit is an induction heating unit. In a preferred embodiment, the device is configured such that the first (induction) heating unit reaches its maximum operating temperature at a rate of at least 100 °C per second. In a particularly preferred embodiment, the device is configured such that the first (induction) heating unit reaches the maximum operating temperature at a rate of at least 150 °C per second.

Induction heating systems may also be advantageous because the varying magnetic field magnitude can be easily controlled by controlling power supplied to the heating unit. Moreover, as induction heating does not require a physical connection to be provided between the source of the varying magnetic field and the heat source, design freedom and control over the heating profile may be greater, and cost may be lower.

In other examples, the first and/or second heating unit may comprise a resistive heating unit. A resistive heating unit may consist of a resistive heating element. That is, it may be unnecessary for a resistive heating unit to include a separate component for transducing the electrical energy received by the heating unit, because a resistive heating element itself transduces electrical energy to thermal energy.

Using electrical resistance heating systems may be advantageous because the rate of heat generation is easier to control, and lower levels of heat are easier to generate, compared with using combustion for heat generation. The use of electrical heating systems therefore allows greater control over the generation of an aerosol from a tobacco composition.

Reference is made to the temperature of heating elements throughout the present specification. The temperature of a heating element may also be conveniently referred to as the temperature of the heating unit which comprises the heating element. This does not necessarily mean that the entire heating unit is at the given temperature. For example, where reference is made to the temperature of an induction heating unit, it does not necessarily mean that the both the inductive element and the susceptor have such a temperature. Rather, in this example, the temperature of the induction heating unit corresponds to the temperature of the heating element composed in the induction heating unit. For the avoidance of doubt, the temperature of a heating element and the temperature of a heating unit can be used interchangeably.

As used herein, “temperature profile” refers to the variation of temperature of a material over time. For example, the varying temperature of a heating element or heating unit measured at the heating element or heating unit for the duration of a smoking session may be referred to as the temperature profile of that heating element or heating unit. The heating elements or heating units provide heat to the aerosol-generating material during use, to generate an aerosol. The temperature profile of the heating element or heating unit therefore induces the temperature profile of aerosol-generating material disposed near the heating element or heating unit.

As used herein, “puff” refers to a single inhalation by the user of the aerosol generated by the aerosol-generating device.

In use, the device preferably heats an aerosol-generating material to provide an inhalable aerosol. The device may be referred to as “ready for use” when at least a portion of the aerosol-generating material has reached a lowest operating temperature and a user can take a puff which contains a satisfactory amount of aerosol. In some embodiments the device may be ready for use within approximately 20 seconds of supplying power to the first heating unit, or 15 seconds, or 10 seconds. Preferably, the device is ready for use within approximately 20 seconds of activation of the device, or 15 seconds, or 10 seconds. The device may begin supplying power to a heating unit such as the first heating unit when the device is activated, or it may begin supplying power to the heating unit after the device is activated. Preferably, the device is configured such that power starts being supplied to the first heating unit some time after activation of the device, such as at least 1 second, 2 seconds or 3 seconds after activation of the device. Preferably, the device is configured such that power is not supplied to the first heating unit, or any heating unit present in the heating assembly until at least 2.5 seconds after activation of the device. This may advantageously prolong battery life by avoiding unintentional activation of the heating unit(s).

The aerosol-generating device may be ready for use more quickly than corresponding aerosol-generating devices known in the art, providing an improved user experience. Generally, the point at which the device is ready for use will be some time after the first heating unit has reached its maximum operating temperature, as it will take some amount of time to transfer sufficient thermal energy from the heating unit to the aerosol-generating material in order to generate the aerosol. Preferably, the device is ready for use within 20 seconds of the first heating unit reaching its maximum operating temperature, or 15 seconds, or 10 seconds.

It has been found that characteristics of the aerosol generated from the aerosol-generating material may depend on the rate at which the aerosol-generating material is heated. For example, the aerosol generated from an aerosol-generating material which is subject to heating from a heating unit which is configured to change temperature quickly may provide an improved user experience. In one embodiment wherein the aerosol-generating material comprises menthol, it has been found that rapidly increasing the temperature of the heating unit may increase the rate at which menthol is delivered to a user in the aerosol, and thereby reduce the amount of menthol component that is wasted (i.e. does not form part of the aerosol inhaled by a user) from static heating.

In some embodiments, the user's sensorial experience arising from the aerosol generated by the present device is like that of smoking a combustible cigarette, such as a factory-made cigarette.

The device may indicate that it is ready for use via an indicator. In a preferred embodiment, the device may be configured such that the indicator indicates that the device is ready for use within approximately 20 seconds of power being supplied to the first heating unit, or 15 seconds, or 10 seconds. In a particularly preferred embodiment, the device is configured such that the indicator indicates that the device is ready for use within approximately 20 seconds of activation of the device, or 15 seconds, or 10 seconds. In another preferred embodiment, the device is configured such that the indicator indicates that the device is ready for use within approximately 20 seconds of the first heating unit reaching its maximum operating temperature, or 15 seconds, or 10 seconds.

“Session of use” as used herein refers to a single period of use of the aerosol-generating device by a user. The session of use begins at the point at which power is first supplied to at least one heating unit present in the heating assembly. The device will be ready for use after a period of time has elapsed from the start of the session of use. The session of use ends at the point at which no power is supplied to any of the heating units in the aerosol-generating device. The end of the session of use may coincide with the point at which the aerosol-generating article is depleted (the point at which the total particulate matter yield (mg) in each puff would be deemed unacceptably low by a user). The session preferably comprises a plurality of puffs. The session may have a duration less than 7 minutes, or 6 minutes, or 5 minutes, or 4 minutes and 30 seconds, or 4 minutes, or 3 minutes and 30 seconds. In some embodiments, the session of use may have a duration of from 2 to 5 minutes, or from 3 to 4.5 minutes, or 3.5 to 4.5 minutes, or suitably 4 minutes. A session may be initiated by the user actuating a button or switch on the device, causing at least one heating unit to begin rising in temperature when activated or some time after activation.

“Operating temperature” as used herein in relation to a heating element or heating unit refers to any heating element temperature at which the element can heat an aerosol-generating material to produce sufficient aerosol for a satisfactory puff without burning the aerosol-generating material. The maximum operating temperature of a heating element is the highest temperature reached by the element during a smoking session. The lowest operating temperature of the heating element refers to the lowest heating element temperature at which sufficient aerosol can be generated from the aerosol-generating material by the heating element for a satisfactory puff. Where there is a plurality of heating elements or heating units present in the aerosol-generating device, each heating element or heating unit has an associated maximum operating temperature. The maximum operating temperature of each heating element or heating unit may be the same, or it may differ for each heating element or heating unit.

In the aerosol-generating device according to a preferred embodiment of the present invention, each heating element or heating unit is preferably arranged to heat, but not burn, aerosol-generating material. Although the temperature profile of each heating element or heating unit preferably induces the temperature profile of each associated portion of aerosol-generating material, the temperature profiles of the heating element or heating unit and the associated portion of aerosol-generating material may not exactly correspond. For example: there may be “bleed” in the form of conduction, convection and/or radiation of heat energy from one portion of the aerosol-generating material to another; there may be variations in conduction, convection and/or radiation of heat energy from the heating elements or heating units to the aerosol-generating material; there may be a lag between the change in the temperature profile of the heating element or heating unit and the change in the temperature profile of the aerosol-generating material, depending on the heat capacity of the aerosol-generating material.

The device preferably comprises a controller for controlling each heating unit present in the device. The controller may comprise a PCB. The controller is preferably configured to control the power supplied to each heating unit, and controls the “programmed heating profile” of each heating unit present in the device. For example, the controller may be programmed to control the current supplied to a plurality of inductors to control the resulting temperature profiles of the corresponding induction heating elements or induction heating units. As between the temperature profile of heating elements/units and aerosol-generating material described above, the programmed heating profile of a heating element or heating unit may not exactly correspond to the observed temperature profile of a heating element or heating unit, for the same reasons given above.

The term “operating temperature” can also be used in relation to the aerosol-generating material. In this case, the term refers to any temperature of the aerosol-generating material itself at which sufficient aerosol is generated from the aerosol-generating material for a satisfactory puff. The maximum operating temperature of the aerosol-generating material is the highest temperature reached by any part of the aerosol-generating material during a smoking session. In some embodiments, the maximum operating temperature of the aerosol-generating material is greater than 200 °C, 210 °C, 220 °C, 230 °C, 240 °C, 250 °C, 260 °C, or 270 °C. In some embodiments, the maximum operating temperature of the aerosol-generating material is less than 300 °C, 290 °C, 280 °C, 270 °C, 260 °C, 250 °C. The lowest operating temperature is the lowest temperature of aerosol-generating material at which sufficient aerosol is generated from the material to product sufficient aerosol for a satisfactory “puff”. In some embodiments, the lowest operating temperature of the aerosol-generating material is greater than 90 °C, 100 °C, 110 °C, 120 °C, 130 °C, 140 °C or 150 °C. In some embodiments, the lowest operating temperature of the aerosol-generating material is less than 150 °C, 140 °C, 130 °C, or 120 °C.

An object of various preferred embodiments of the present invention is to reduce the amount of time it takes for an aerosol-generating device to be ready for use, and more generally improve the inhalation experience for a user. Surprisingly, it has been found that reducing the time taken for a heating element or heating unit to reach an operating temperature may at least partially alleviate “hot puff”, a phenomenon which occurs when the generated aerosol contains a high water content. Accordingly, the aerosol-generating device according to various embodiments of the present invention may provide an inhalable aerosol to a consumer which has better organoleptic properties than an aerosol provided by an aerosol-generating device of the prior art which does not include a heating unit which reaches a maximum operating temperature as rapidly.

In some embodiments, the device is configured such that at least one heating element in the device reaches its maximum operating temperature within 20 seconds, and the first temperature at which the at least one heating unit is held for at least 1 second, 2 seconds, 3 seconds, 4 seconds, 5 seconds, 10 seconds, or 20 seconds is the maximum operating temperature. That is, in these embodiments, the heating unit is not held at a temperature which is not the maximum operating temperature before reaching the maximum operating temperature.

In some embodiments, the at least one heating unit reaches its maximum operating temperature within the given period from ambient temperature.

The device is configured to operate as described herein. The device may at least partially be configured to operate in this manner by a controller which is preferably programmed to operate the device in one or more different modes. Accordingly, references herein to the configuration of the device or components thereof may refer to the controller being programmed to operate the device as disclosed herein, amongst other features (such as spatial arrangement of the heating units).

Aerosol-generating articles for aerosol-generating devices (such as tobacco heating products) usually contain more water and/or aerosol-generating agent than combustible smoking articles to facilitate formation of an aerosol in use. This higher water and/or aerosol-generating agent content can increase the risk of condensate collecting within the aerosol-generating device during use, particularly in locations away from the heating unit(s). This problem may be greater in devices with enclosed heating chambers, and particularly those with external heaters, than those provided with internal heaters (such as “blade” heaters). Without wishing to be bound by theory, it is believed that since a greater proportion/surface area of the aerosol-generating material is heated by external-heating heating assemblies, more aerosol is released than a device which heats the aerosol-generating material internally, leading to more condensation of the aerosol within the device. The inventors have found that programmed heating profiles of the present disclosure may advantageously be employed in a device configured to externally heat aerosol-generating material to provide a desirable amount of aerosol to the user whilst keeping the amount of aerosol which condenses inside the device low. For example, the maximum operating temperature of a heating unit may affect the amount of condensate formed. It may be that lower maximum operating temperatures provide less undesirable condensate. The difference between maximum operating temperatures of heating units in a heating assembly may also affect the amount of condensate formed. Further, the point in a session of use at which each heating unit reaches its maximum operating temperature may affect the amount of condensate formed.

In some embodiments, the device is operable in at least a first (e.g. base) mode and a second (e.g. boost) mode.

The heating assembly may be operable in a maximum of two modes, or may be operable in more than two modes, such as three modes, four modes, or five modes.

Each mode may be associated with a predetermined heating profile for each heating unit in the heating assembly, such as a programmed heating profile. One or more of the programmed heating profiles may be programmed by a user. Additionally, or alternatively, one or more of the programmed heating profiles may be programmed by the manufacturer. In these examples, the one or more programmed heating profiles may be fixed such that an end user cannot alter the one or more programmed heating profiles.

The modes of operation may be selectable by a user. For example, the user may select a desired mode of operation by interacting with a user interface. Preferably, power begins to be supplied to the first heating unit at substantially the same time as the desired mode of operation is selected.

Each mode may be associated with a temperature profile which differs from the temperature profiles of the other modes. Further, one or more modes may be associated with a different point at which the device is ready for use. For example, the heating assembly may configured such that, in the first mode, the device is ready for use a first period of time after the start of a session of use, and in the second mode, the device is ready for use a second period of time after the start of the session. The first period of time may be different from the second period of time. Preferably, the second period of time associated with the second mode is shorter than the first period of time associated with the second mode.

In some examples, the heating assembly is configured such that the device is ready for use within 30, 25 seconds, 20 seconds or 15 seconds of supplying power to the first heating unit when operated in the first mode. The heating assembly may also be configured such that the device is ready for use in a shorter period of time when operating in the second mode—within 25 seconds, 20 seconds, 15 seconds, or 10 seconds of supplying power to the first heating unit when operating in the second mode. Preferably, the heating assembly is configured such that the device is ready for use within 20 seconds of supplying power to the first heating unit when operated in the first mode, and within 10 seconds of supplying power to the second heating unit when operated in the second mode. Advantageously, the second mode of this embodiment may also be associated with the first and/or second heating unit having a higher maximum operating temperature in use.

In a particularly preferred embodiment, the device is configured such that the indicator indicates that the device is ready for use within 20 seconds of selection of the first (e.g. base) mode, and within 10 seconds of selection of the second (e.g. boost) mode.

Providing an aerosol-generating device such as a tobacco heating product with a heating assembly that is operable in a plurality of modes (e.g. base mode and boost mode) advantageously gives more choice to the consumer, particularly where each mode is associated with a different maximum heater temperature. Moreover, such a device is capable of providing different aerosols having differing characteristics, because volatile components in the aerosol-generating material will be volatilized at different rates and concentrations at different heater temperatures. This allows a user to select a particular mode based on a desired characteristic of the inhalable aerosol, such as degree of tobacco flavor, nicotine concentration, and aerosol temperature. For example, modes in which the device is ready for use more quickly (e.g. a second or “boost” mode) may provide a quicker first puff, or a greater nicotine content per puff, or a more concentrated flavor per puff. Conversely, modes in which the device is ready for use at a later point in the session (e.g. a first or base mode) of use may provide a longer overall session of use, lower nicotine content per puff, and more sustained delivery of flavor.

In embodiments wherein the device is ready for use more quickly in a second (e.g. boost) mode, and/or the first and/or second heating unit has a higher maximum operating temperature in the second mode, the second mode may be referred to as a “boost” mode. For the first time, aspects of the present invention provide an aerosol-generating device which is operable in a first “normal” mode, and a second “boost” mode. The “boost” mode may advantageously provide a quicker first puff, or a greater nicotine content per puff, or a more concentrated flavor per puff.

The device may comprise a maximum of two heating units. In other examples, the device may comprise more than two independently controllable heating units, such as three, four or five independently controllable heating units.

Preferably, the device is configured such that each heating unit present in the device reaches a first-mode maximum operating temperature in the first mode, and a second-mode maximum operating temperature in the second mode. For example, the second heating unit may reach a first-mode maximum operating temperature in the first mode, and a second-mode maximum operating temperature in the second mode. The maximum operating temperature of each heating unit in each mode may be the same, or may be different. For example, the maximum operating temperature of the second heating unit in each mode may or may not be the same as the maximum operating temperature of the first heating unit in each mode.

As discussed hereinabove, in some embodiments, at least one of the heating units provided in the heating assembly preferably comprises an induction heating unit. In these embodiments, the heating unit comprises an inductor (for example, one or more inductor coils), and the device is preferably arranged to pass a varying electrical current, such as an alternating current, through the inductor. The varying electric current in the inductor produces a varying magnetic field. When the inductor and the heating element are suitably relatively positioned so that the varying magnetic field produced by the inductor penetrates the heating element, one or more eddy currents are generated inside the heating element. The heating element has a resistance to the flow of electrical currents, so when such eddy currents are generated in the object, their flow against the electrical resistance of the object causes the object to be heated by Joule heating. Supplying a varying magnetic field to a susceptor may conveniently be referred to as supplying energy to a susceptor.

The first and second heating units (which may comprise induction or resistive heating units) are preferably controllable independent from each other. Heating the aerosol-generating material with independent heating units may advantageously provide more accurate control of heating of the aerosol-generating material. Independently controllable heating units may also provide thermal energy differently to each portion of the aerosol-generating material, resulting in differing temperature profiles across portions of the aerosol-generating material. In particular embodiments, the first and second heating units are configured to have temperature profiles which differ from each other in use. This may provide asymmetrical heating of the aerosol-generating material along a longitudinal plane between the mouth end and the distal end of the device when the device is in use.

An object that is capable of being inductively heated is known as a susceptor. In cases where the susceptor comprises ferromagnetic material such as iron, nickel or cobalt, heat may also be generated by magnetic hysteresis losses in the susceptor, i.e. by the varying orientation of magnetic dipoles in the magnetic material as a result of their alignment with the varying magnetic field. In inductive heating, as compared to heating by conduction for example, heat is generated inside the susceptor, allowing for rapid heating. Further, there need not be any physical contact between the inductive heater and the susceptor, allowing for enhanced freedom in construction and application.

The heating element may comprise a susceptor. In preferred embodiments, the susceptor comprises a plurality of heating elements—at least a first induction heating element and a second induction heating element.

In other embodiments, the heating units are not limited to induction heating units. For example, the first heating unit may comprise an electrical resistance heating unit which may consist of a resistive heating element. The second heating unit may additionally or alternatively be an electrical resistance heating unit which may consist of a resistive heating element. By “resistive heating element”, it is meant that on application of a current to the element, resistance in the element transduces electrical energy into thermal energy which heats the aerosol-generating substrate. The heating element may be in the form of a resistive wire, mesh, coil and/or a plurality of wires. The heat source may comprise a thin-film heater.

The heating element may comprise a metal or metal alloy. Metals are excellent conductors of electricity and thermal energy. Suitable metals include but are not limited to: copper, aluminum, platinum, tungsten, gold, silver, and titanium. Suitable metal alloys include but are not limited to: nichrome and stainless steel.

Another aspect of the present invention is an aerosol-generating system comprising an aerosol-generating device as described herein in combination with an aerosol-generating article. In a preferred embodiment, the aerosol-generating system comprises a tobacco heating product in combination with an aerosol-generating article comprising tobacco. In suitable embodiments the tobacco heating product may comprise the heating arrangement and aerosol-generating article described in relation to the figures hereinbelow.

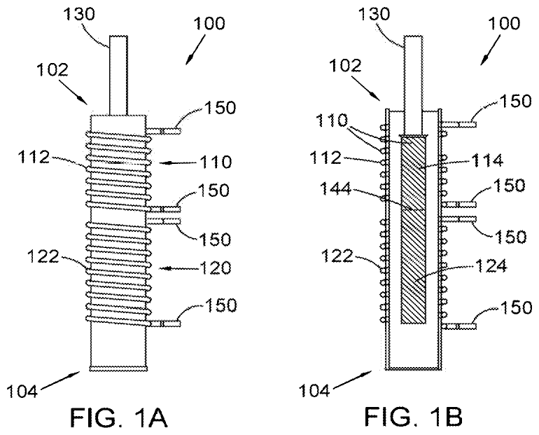

FIG. 1A shows a heating assembly 100 of an aerosol-generating device according to an embodiment. The heating assembly 100 is an induction heating assembly 100. FIG. 1B shows a cross section of the induction heating assembly 100 of the device.

The heating assembly 100 has a first or proximal or mouth end 102, and a second or distal end 104. In use, the user will inhale the formed aerosol from the mouth end of the aerosol-generating device. The mouth end may be an open end.

The heating assembly 100 comprises a first heating unit 110 and a second heating unit 120. The first and second heating units 110 120 are both induction heating units. The first induction heating unit 110 comprises a first inductor coil 112 and a first heating element 114. The second induction heating unit 120 comprises a second inductor coil 122 and a second heating element 124.

The first heating unit 110 is spatially separated from the second heating unit 120. There is no overlap between the inductor coils of the heating units 110 120. The first heating unit 110 is closer to the mouth end than the second heating unit 120.

FIGS. 1A and 1B show an aerosol-generating article 130 received within a susceptor 140 (see FIG. 1i). The susceptor 140 forms the first induction heating element 114 and the second induction heating element 124. The susceptor 140 may be formed from any material suitable for heating by induction. For example, the susceptor 140 may comprise metal. In some embodiments, the susceptor 140 may comprise non-ferrous metal such as copper, nickel, titanium, aluminum, tin, or zinc, and/or ferrous material such as iron, nickel or cobalt. Additionally or alternatively the susceptor 140 may comprise a semiconductor such as silicon carbide, carbon or graphite.

Each induction heating element present in the aerosol-generating device may have any suitable shape. In the embodiment shown in FIG. 1B, the induction heating elements 114, 124 define a receptacle to surround an aerosol-generating article and heat the aerosol-generating article externally. In other embodiments (not shown), one or more induction heating elements may be substantially elongate, arranged to penetrate an aerosol-generating article and heat the aerosol-generating article internally.

As shown in FIG. 1B, the first induction heating element 114 and second induction heating element 124 may be provided together as a monolithic element 140. That is, in some embodiments, there is no physical distinction between the first 114 and second 124 heating elements. Rather, the differing characteristics between the first and second heating units 110, 120 are defined by separate inductor coils 112, 122 surrounding each induction heating element 114, 124, so that they may be controlled independently from each other. In other embodiments (not depicted), physically distinct inductive heating elements may be employed.

The first and second inductor coils 112, 122 are preferably made from an electrically conducting material. In this example, the first and second inductor coils 112, 122 are made from Litz wire/cable which is wound in a helical fashion to provide helical inductor coils 112, 122. Litz wire comprises a plurality of individual wires which are individually insulated and are twisted together to form a single wire. Litz wires are designed to reduce the skin effect losses in a conductor. In the example induction heating assembly 100, the first and second inductor coils 124, 126 are made from copper Litz wire which has a circular cross section. In other examples the Litz wire can have other shape cross sections, such as rectangular.

The first inductor coil 112 is configured to generate a first varying magnetic field for heating the first induction heating element 114, and the second inductor coil 122 is configured to generate a second varying magnetic field for heating a second section of the susceptor 124. The first inductor coil 112 and the first induction heating element 114 taken together form a first induction heating unit 110. Similarly, the second inductor coil 122 and the second induction heating element 124 taken together form a second induction heating unit 120.

In this example, the first inductor coil 112 is adjacent to the second inductor coil 122 in a direction along the longitudinal axis of the device heating assembly 100 (that is, the first and second inductor coils 112, 122 do not overlap). The susceptor arrangement 140 may comprise a single susceptor. Ends 150 of the first and second inductor coils 112, 122 can be connected to a controller such as a PCB (not shown). In preferred embodiments, the controller comprises a PID controller (proportional integral derivative controller).

The varying magnetic field generates eddy currents within the first inductive heating element 114, thereby rapidly heating the first induction heating element 114 to a maximum operating temperature within a short period of time from supplying the alternative current to the coil 112, for example within 20, 15, 12, 10, 5, or 2 seconds. Arranging the first induction heating unit 110 which is configured to rapidly reach a maximum operating temperature closer to the mouth end 102 of the heating assembly 100 than the second induction heating unit 120 may mean that an acceptable aerosol is provided to a user as soon as possible after initiation of a session of use.

It will be appreciated that the first and second inductor coils 112, 122, in some examples, may have at least one characteristic different from each other. For example, the first inductor coil 112 may have at least one characteristic different from the second inductor coil 122. More specifically, in one example, the first inductor coil 112 may have a different value of inductance than the second inductor coil 122. In FIGS. 1A and 1, the first and second inductor coils 112, 122 are of different lengths such that the first inductor coil 112 is wound over a smaller section of the susceptor 140 than the second inductor coil 122. Thus, the first inductor coil 112 may comprise a different number of turns than the second inductor coil 122 (assuming that the spacing between individual turns is substantially the same). In yet another example, the first inductor coil 112 may be made from a different material to the second inductor coil 122. In some examples, the first and second inductor coils 112, 122 may be substantially identical.

In this example, the first inductor coil 112 and the second inductor coil 122 are wound in the same direction. However, in another embodiment, the inductor coils 112, 122 may be wound in opposite directions. This can be useful when the inductor coils are active at different times. For example, initially, the first inductor coil 112 may be operating to heat the first induction heating element 114, and at a later time, the second inductor coil 122 may be operating to heat the second induction heating element 124. Winding the coils in opposite directions helps reduce the current induced in the inactive coil when used in conjunction with a particular type of control circuit. In one example, the first inductor coil 112 may be a right-hand helix and the second inductor coil 122 a left-hand helix. In another example, the first inductor coil 112 may be a left-hand helix and the second inductor coil 122 may be a right-hand helix.

The coils 112, 122 may have any suitable geometry. Without wishing to be bound by theory, configuring an induction heating element to be smaller (e.g. smaller pitch helix; fewer revolutions in the helix; shorter overall length of the helix), may increase the rate at which the induction heating element can reach a maximum operating temperature. In some embodiments, the first coil 112 may have a length of less than approximately 20 mm, less than 18 mm, less than 16 mm, or a length of approximately 14 mm, in the longitudinal direction of the heating assembly 100. Preferably, the first coil 112 may have a length shorter than the second coil 124 in the longitudinal direction of the heating assembly 100. Such an arrangement may provide asymmetrical heating of the aerosol-generating article along the length of the aerosol-generating article.

The susceptor 140 of this example is hollow and therefore defines a receptacle within which aerosol-generating material is received. For example, the article 130 can be inserted into the susceptor 140. In this example the susceptor 140 is tubular, with a circular cross section.

The induction heating elements 114 and 124 are arranged to surround the aerosol-generating article 130 and heat the aerosol-generating article 130 externally. The aerosol-generating device is configured such that, when the aerosol-generating article 130 is received within the susceptor 140, the outer surface of the article 130 abuts the inner surface of the susceptor 140. This ensures that the heating is most efficient. The article 130 of this example comprises aerosol-generating material. The aerosol-generating material is positioned within the susceptor 140. The article 130 may also comprise other components such as a filter, wrapping materials and/or a cooling structure.

The heating assembly 100 is not limited to two heating units. In some examples, the heating assembly 100 may comprise three, four, five, six, or more than six heating units. These heating units may each be controllable independent from the other heating units present in the heating assembly 100.

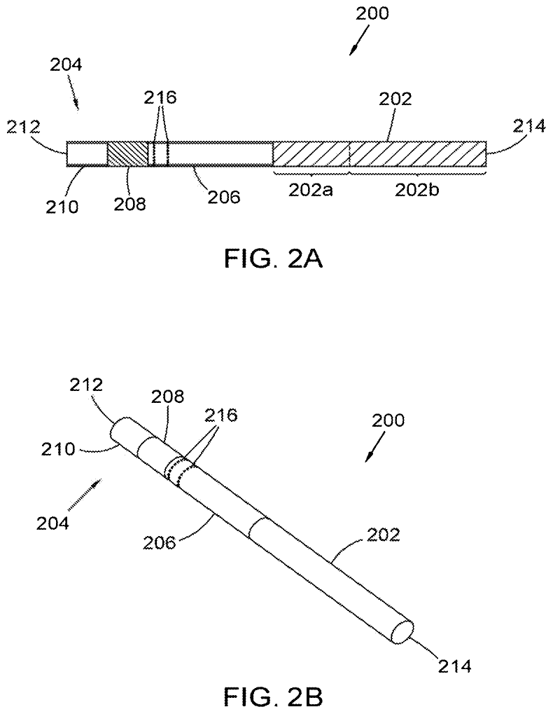

Referring to FIGS. 2A and 2B, there is shown a partially cut-away section view and a perspective view of an example of an aerosol-generating article 200. The aerosol-generating article 200 shown in FIGS. 2A and 2B corresponds to the aerosol-generating article 130 shown in FIG. 1.

The aerosol-generating article 200 may be any shape suitable for use with an aerosol-generating device. The aerosol-generating article 130 may be in the form of or provided as part of a cartridge or cassette or rod which can be inserted into the apparatus. In the embodiment shown in FIGS. 1A and 1B and 2, the aerosol-generating article 130 is in the form of a substantially cylindrical rod that includes a body of smokable material 202 and a filter assembly 204 in the form of a rod. The filter assembly 204 includes three segments, a cooling segment 206, a filter segment 208 and a mouth end segment 210. The article 200 has a first end 212, also known as a mouth end or a proximal end and a second end 214, also known as a distal end. The body of aerosol-generating material 202 is located towards the distal end 214 of the article 200. In one example, the cooling segment 206 is located adjacent the body of aerosol-generating material 202 between the body of aerosol-generating material 202 and the filter segment 208, such that the cooling segment 206 is in an abutting relationship with the aerosol-generating material 202 and the filter segment 208. In other examples, there may be a separation between the body of aerosol-generating material 202 and the cooling segment 206 and between the body of aerosol-generating material 202 and the filter segment 208. The filter segment 208 is located in between the cooling segment 206 and the mouth end segment 210. The mouth end segment 210 is located towards the proximal end 212 of the article 200, adjacent the filter segment 208. In one example, the filter segment 208 is in an abutting relationship with the mouth end segment 210. In one embodiment, the total length of the filter assembly 204 is between 37 mm and 45 mm, more preferably, the total length of the filter assembly 204 is 41 mm.

In use, portions 202a and 202b of the body of aerosol-generating material 202 may correspond to the first induction heating element 114 and second induction heating element 124 of the portion 100 shown in FIG. 1B respectively.

The body of smokable material may have a plurality of portions 202a, 202b which correspond to the plurality of induction heating elements present in the aerosol-generating device. For example, the aerosol-generating article 200 may have a first portion 202a which corresponds to the first induction heating element 114 and a second portion 202b which corresponds to the second induction heating element 124. These portions 202a, 202b may exhibit temperature profiles which are different from each other during a session of use; the temperature profiles of the portions 202a, 202b may derive from the temperature profiles of the first induction heating element 114 and second induction heating element 124 respectively.

Where there is a plurality of portions 202a, 202b of a body of aerosol-generating material 202, any number of the substrate portions 202a, 202b may have substantially the same composition. In a particular example, all of the portions 202a, 202b of the substrate have substantially the same composition. In one embodiment, body of aerosol-generating material 202 is a unitary, continuous body and there is no physical separation between the first and second portions 202a, 202b, and the first and second portions have substantially the same composition.

In one embodiment, the body of aerosol-generating material 202 comprises tobacco. However, in other respective embodiments, the body of smokable material 202 may consist of tobacco, may consist substantially entirely of tobacco, may comprise tobacco and aerosol-generating material other than tobacco, may comprise aerosol-generating material other than tobacco, or may be free of tobacco. The aerosol-generating material may include an aerosol generating agent, such as glycerol.

In a particular embodiment, the aerosol-generating material may comprise one or more tobacco components, filler components, binders and aerosol generating agents.

The filler component may be any suitable inorganic filler material. Suitable inorganic filler materials include, but are not limited to: calcium carbonate (i.e. chalk), perlite, vermiculite, diatomaceous earth, colloidal silica, magnesium oxide, magnesium sulphate, magnesium carbonate, and suitable inorganic sorbents, such as molecular sieves. Calcium carbonate is particularly suitable. In some cases, the filler comprises an organic material such as wood pulp, cellulose and cellulose derivatives.

The binder may be any suitable binder. In some embodiments, the binder comprises one or more of an alginate, celluloses or modified celluloses, polysaccharides, starches or modified starches, and natural gums.

Suitable binders include, but are not limited to: alginate salts comprising any suitable cation, such as sodium alginate, calcium alginate, and potassium alginate; celluloses or modified celluloses, such as hydroxypropyl cellulose and carboxymethylcellulose; starches or modified starches; polysaccharides such as pectin salts comprising any suitable cation, such as sodium, potassium, calcium or magnesium pectate; xanthan gum, guar gum, and any other suitable natural gums.

A binder may be included in the aerosol-generating material in any suitable quantity and concentration.

The “aerosol-generating agent” is an agent that promotes the generation of an aerosol. An aerosol-generating agent may promote the generation of an aerosol by promoting an initial vaporization and/or the condensation of a gas to an inhalable solid and/or liquid aerosol. In some embodiments, an aerosol-generating agent may improve the delivery of flavor from the aerosol-generating article.

In general, any suitable aerosol-generating agent or agents may be included in the aerosol-generating material. Suitable aerosol-generating agent include, but are not limited to: a polyol such as sorbitol, glycerol, and glycols like propylene glycol or triethylene glycol; a non-polyol such as monohydric alcohols, high boiling point hydrocarbons, acids such as lactic acid, glycerol derivatives, esters such as diacetin, triacetin, triethylene glycol diacetate, triethyl citrate or myristates including ethyl myristate and isopropyl myristate and aliphatic carboxylic acid esters such as methyl stearate, dimethyl dodecanedioate and dimethyl tetradecanedioate.

In a particular embodiment, the aerosol-generating material comprises a tobacco component in an amount of from 60 to 90% by weight of the tobacco composition, a filler component in an amount of 0 to 20% by weight of the tobacco composition, and an aerosol generating agent in an amount of from 10 to 20% by weight of the tobacco composition. The tobacco component may comprise paper reconstituted tobacco in an amount of from 70 to 100% by weight of the tobacco component.

In one example, the body of aerosol-generating material 202 is between 34 mm and 50 mm in length, more preferably, the body of aerosol-generating material 202 is between 38 mm and 46 mm in length, more preferably still, the body of aerosol-generating material 202 is 42 mm in length.

In one example, the total length of the article 200 is between 71 mm and 95 mm, more preferably, total length of the article 200 is between 79 mm and 87 mm, more preferably still, total length of the article 200 is 83 mm.

An axial end of the body of aerosol-generating material 202 is visible at the distal end 214 of the article 200. However, in other embodiments, the distal end 214 of the article 200 may comprise an end member (not shown) covering the axial end of the body of aerosol-generating material 202.

The body of aerosol-generating material 202 is joined to the filter assembly 204 by annular tipping paper (not shown), which is located substantially around the circumference of the filter assembly 204 to surround the filter assembly 204 and extends partially along the length of the body of aerosol-generating material 202. In one example, the tipping paper is made of 58GSM standard tipping base paper. In one example has a length of between 42 mm and 50 mm, and more preferably, the tipping paper has a length of 46 mm.

In one example, the cooling segment 206 is an annular tube and is located around and defines an air gap within the cooling segment. The air gap provides a chamber for heated volatilized components generated from the body of aerosol-generating material 202 to flow. The cooling segment 206 is hollow to provide a chamber for aerosol accumulation yet rigid enough to withstand axial compressive forces and bending moments that might arise during manufacture and whilst the article 200 is in use during insertion into the device 100. In one example, the thickness of the wall of the cooling segment 206 is approximately 0.29 mm.

The cooling segment 206 provides a physical displacement between the aerosol-generating material 202 and the filter segment 208. The physical displacement provided by the cooling segment 206 will provide a thermal gradient across the length of the cooling segment 206. In one example the cooling segment 206 is configured to provide a temperature differential of at least 40 °C between a heated volatilized component entering a first end of the cooling segment 206 and a heated volatilized component exiting a second end of the cooling segment 206. In one example the cooling segment 206 is configured to provide a temperature differential of at least 60 °C between a heated volatilized component entering a first end of the cooling segment 206 and a heated volatilized component exiting a second end of the cooling segment 206. This temperature differential across the length of the cooling element 206 protects the temperature sensitive filter segment 208 from the high temperatures of the aerosol-generating material 202 when it is heated by the heating assembly 100 of the device aerosol-generating device. If the physical displacement was not provided between the filter segment 208 and the body of aerosol-generating material 202 and the heating elements 114, 124 of the heating assembly 100, then the temperature sensitive filter segment may 208 become damaged in use, so it would not perform its required functions as effectively.

In one example the length of the cooling segment 206 is at least 15 mm. In one example, the length of the cooling segment 206 is between 20 mm and 30 mm, more particularly 23 mm to 27 mm, more particularly 25 mm to 27 mm and more particularly 25 mm.

The cooling segment 206 is made of paper, which means that it is comprised of a material that does not generate compounds of concern, for example, toxic compounds when in use adjacent to the heater assembly 100 of the aerosol-generating device. In one example, the cooling segment 206 is manufactured from a spirally wound paper tube which provides a hollow internal chamber yet maintains mechanical rigidity. Spirally wound paper tubes are able to meet the tight dimensional accuracy requirements of high-speed manufacturing processes with respect to tube length, outer diameter, roundness and straightness.

In another example, the cooling segment 206 is a recess created from stiff plug wrap or tipping paper. The stiff plug wrap or tipping paper is manufactured to have a rigidity that is sufficient to withstand the axial compressive forces and bending moments that might arise during manufacture and whilst the article 200 is in use during insertion into the device 100.

For each of the examples of the cooling segment 206, the dimensional accuracy of the cooling segment is sufficient to meet the dimensional accuracy requirements of high-speed manufacturing process.

The filter segment 208 may be formed of any filter material sufficient to remove one or more volatilized compounds from heated volatilized components from the smokable material. In one example the filter segment 208 is made of a mono-acetate material, such as cellulose acetate. The filter segment 208 provides cooling and irritation-reduction from the heated volatilized components without depleting the quantity of the heated volatilized components to an unsatisfactory level for a user.

The density of the cellulose acetate tow material of the filter segment 208 controls the pressure drop across the filter segment 208, which in turn controls the draw resistance of the article 200. Therefore, the selection of the material of the filter segment 208 is important in controlling the resistance to draw of the article 200. In addition, the filter segment 208 performs a filtration function in the article 200.

In one example, the filter segment 208 is made of a 8Y15 grade of filter tow material, which provides a filtration effect on the heated volatilized material, whilst also reducing the size of condensed aerosol droplets which result from the heated volatilized material which consequentially reduces the irritation and throat impact of the heated volatilized material to satisfactory levels.

The presence of the filter segment 208 provides an insulating effect by providing further cooling to the heated volatilized components that exit the cooling segment 206. This further cooling effect reduces the contact temperature of the user's lips on the surface of the filter segment 208.

One or more flavors may be added to the filter segment 208 in the form of either direct injection of flavored liquids into the filter segment 208 or by embedding or arranging one or more flavored breakable capsules or other flavor carriers within the cellulose acetate tow of the filter segment 208.

In one example, the filter segment 208 is between 6 mm to 10 mm in length, more preferably 8 mm.

The mouth end segment 210 is an annular tube and is located around and defines an air gap within the mouth end segment 210. The air gap provides a chamber for heated volatilized components that flow from the filter segment 208. The mouth end segment 210 is hollow to provide a chamber for aerosol accumulation yet rigid enough to withstand axial compressive forces and bending moments that might arise during manufacture and whilst the article is in use during insertion into the device 100. In one example, the thickness of the wall of the mouth end segment 210 is approximately 0.29 mm.

In one example, the length of the mouth end segment 210 is between 6 mm to 10 mm and more preferably 8 mm. In one example, the thickness of the mouth end segment is 0.29 mm.

The mouth end segment 210 may be manufactured from a spirally wound paper tube which provides a hollow internal chamber yet maintains critical mechanical rigidity. Spirally wound paper tubes are able to meet the tight dimensional accuracy requirements of high-speed manufacturing processes with respect to tube length, outer diameter, roundness and straightness.

The mouth end segment 210 provides the function of preventing any liquid condensate that accumulates at the exit of the filter segment 208 from coming into direct contact with a user.

It should be appreciated that, in one example, the mouth end segment 210 and the cooling segment 206 may be formed of a single tube and the filter segment 208 is located within that tube separating the mouth end segment 210 and the cooling segment 206.

A ventilation region 216 is provided in the article 200 to enable air to flow into the interior of the article 200 from the exterior of the article 200. In one example the ventilation region 216 takes the form of one or more ventilation holes 216 formed through the outer layer of the article 200. The ventilation holes may be located in the cooling segment 206 to aid with the cooling of the article 200. In one example, the ventilation region 216 comprises one or more rows of holes, and preferably, each row of holes is arranged circumferentially around the article 200 in a cross-section that is substantially perpendicular to a longitudinal axis of the article 200.

In one example, there are between one to four rows of ventilation holes to provide ventilation for the article 200. Each row of ventilation holes may have between 12 to 36 ventilation holes 216. The ventilation holes 216 may, for example, be between 100 to 500 μm in diameter. In one example, an axial separation between rows of ventilation holes 216 is between 0.25 mm and 0.75 mm, more preferably, an axial separation between rows of ventilation holes 216 is 0.5 mm.

In one example, the ventilation holes 216 are of uniform size. In another example, the ventilation holes 216 vary in size. The ventilation holes can be made using any suitable technique, for example, one or more of the following techniques: laser technology, mechanical perforation of the cooling segment 206 or pre-perforation of the cooling segment 206 before it is formed into the article 200. The ventilation holes 216 are positioned so as to provide effective cooling to the article 200.

In one example, the rows of ventilation holes 216 are located at least 11 mm from the proximal end 212 of the article, more preferably the ventilation holes are located between 17 mm and 20 mm from the proximal end 212 of the article 200. The location of the ventilation holes 216 is positioned such that user does not block the ventilation holes 216 when the article 200 is in use.

Advantageously, providing the rows of ventilation holes between 17 mm and 20 mm from the proximal end 212 of the article 200 enables the ventilation holes 216 to be located outside of the device 100, when the article 200 is fully inserted in the device 100, as can be seen in FIG. 1. By locating the ventilation holes outside of the apparatus, non-heated air is able to enter the article 200 through the ventilation holes from outside the device 100 to aid with the cooling of the article 200.

The length of the cooling segment 206 is such that the cooling segment 206 will be partially inserted into the device 100, when the article 200 is fully inserted into the device 100. The length of the cooling segment 206 provides a first function of providing a physical gap between the heater arrangement of the device 100 and the heat sensitive filter arrangement 208, and a second function of enabling the ventilation holes 216 to be located in the cooling segment, whilst also being located outside of the device 100, when the article 200 is fully inserted into the device 100. As can be seen from FIG. 1, the majority of the cooling element 206 is located within the device 100. However, there is a portion of the cooling element 206 that extends out of the device 100. It is in this portion of the cooling element 206 that extends out of the device 100 in which the ventilation holes 216 are located.

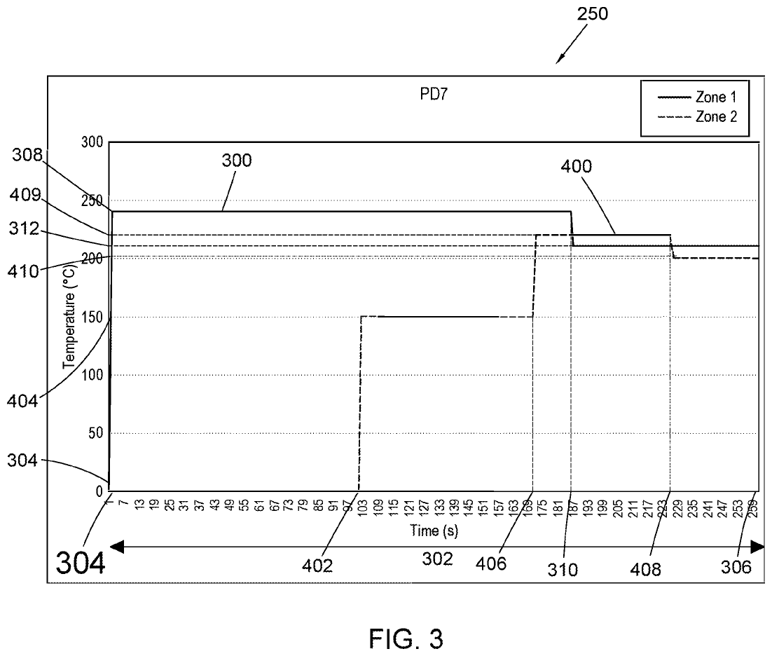

FIG. 3 depicts first and second temperature profiles 300, 400, which form a first heating mode 250 of the aerosol provision device. The first heating mode 250 is a base heating mode.

The first temperature profile 300 shows the temperatures to which a first heating unit 110 is controlled across an aerosol generation session 302, which is also referred to herein as a “session of use” or a “smoking session”.

The temperature of the first heating element 114 is measured by a suitable temperature sensor disposed at the first heating element 114. Suitable temperature sensors include thermocouples, thermopiles or resistance temperature detectors (RTDs, also referred to as resistance thermometers). In a particular embodiment, the device comprises at least one RTD. In a preferred embodiment, the device comprises thermocouples arranged on each heating element 114, 124 present in the aerosol-generating device. The temperature data measured by the or each temperature sensor may be communicated to a controller. Further, it may communicated to the controller when a heating element 114, 124 has reached a prescribed temperature, such that the controller may change the supply of power to elements within the aerosol-generating device accordingly. Preferably, the controller comprises a PID controller, which uses a control loop feedback mechanism to control the temperature of the heating elements based on data supplied from one or more temperature sensors disposed in the device. In a preferred embodiment, the controller comprises a PID controller configured to control the temperature of each heating element based on temperature data supplied from thermocouples disposed at each of the heating elements.

The session of use 302 begins when the device is activated 304 and the controller controls the device to supply energy to at least the first heating unit 110. The device may be activated by a user by, for example, actuating a push button, or inhaling from the device. In the context of a heater assembly comprising induction heating means, the session of use begins when the controller instructs a varying electrical current to be supplied to an inductor (such as first and second coils 112, 122) and thus a varying magnetic field to be supplied to the induction heating element, generating a rise in temperature of the induction heating element. This may conveniently be referred to as “supplying energy to the heating unit”.

The end 306 of the session of use 302 occurs when the controller instructs elements in the device to stop supplying energy to all heating units present in the aerosol-generating device, at time tbase after the smoking session begins. The time tbase is 260 seconds. In the context of a heater assembly comprising induction heating units, the session of use ends when varying electrical current ceases to be supplied to any of the induction heating elements provided in the heating assembly, such that any varying magnetic field ceases to be supplied to the induction heating elements.

At the beginning of the smoking session 302 the temperature of the first heating unit 110 is controlled to a first target operating temperature T1 308.

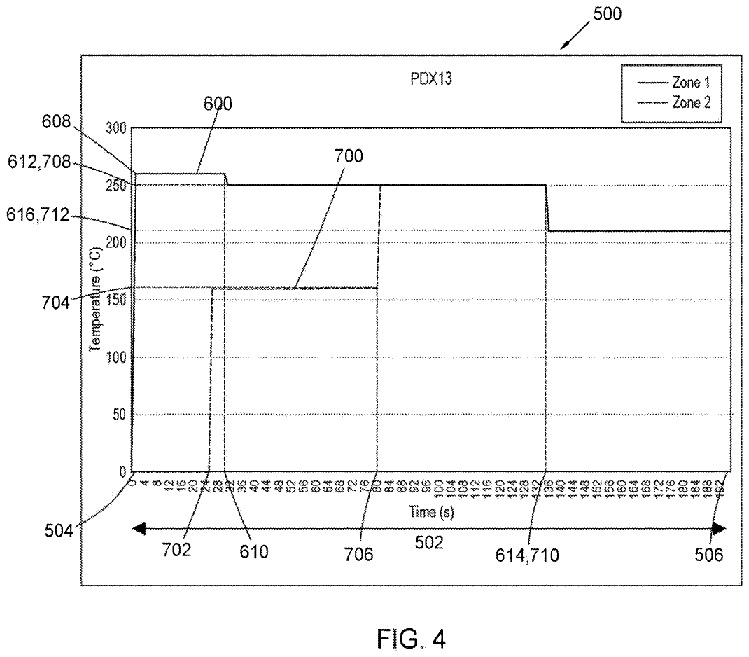

This is achieved by supplying electrical power to the first heating unit 110 and controlling via the controller. It will be appreciated that, while the controller controls the first heating unit 110 to the target temperatures shown in FIG. 3, the actual temperature of the first heating unit 110 in practice will differ slightly from that shown in FIG. 3 and FIG. 4 (for example due to external factors and the time the heating unit takes to heat up).

T1 is the first unit maximum operating temperature, which is the maximum temperature to which the first heating unit 110 is controlled during the session of use 302. In the first heating mode 250 T1 is less than 260 degrees Celsius (deg C). In the first heating mode 250 T1 is less than 250 deg C. In the first heating mode 250 T1 is 240 deg C.

The first heating unit 110 is controlled to maintain its temperature at the first target operating temperature T1 308 until time t4 310. In the first heating mode 250 the time t4 is 185 seconds. All of the times referred to in FIGS. 3 and 4 are measured after the session start 302 i.e. the time that has elapsed since the session start.

At time t4 the first heating unit 110 is controlled to reduce its temperature to a first heating unit step-down temperature T5 312. In the first heating mode 250 T5 is 210 deg C.

The first heating unit 110 is controlled to maintain its temperature at the first unit step-down temperature T5 until the end of the session 306. The end of the session 306 occurs at time tbase. The time tbase is 260 seconds.

The second temperature profile 400 shows the temperatures to which a second heating unit 120 is controlled across the aerosol generation session 302 in the first heating mode.

In the second temperature profile 400 the second heating unit 120 is controlled to an initial second unit temperature T0. During this time, the controller does not supply energy to the second heating unit 120, such that T0 is an unheated temperature. Nevertheless, the temperature at the second induction heating element will likely rise somewhat due to thermal “bleed”—conduction, convection and/or radiation of thermal energy from the first heating element 114 to the second heating element 124.

At time t1 402, the controller begins to supply power to the second heating unit 120. The second heating unit 120 is controlled to a second target operating temperature T2 404.

In the first heating mode 250 the second target operating temperature T2 is less than 160 deg C. In the first heating mode 250 the second target operating temperature T2 is 150 deg C.

In the first heating mode 250 the time t1>85. In the first heating mode 250 the time t1>90. In the first heating mode 250 the time t1>95. In the first heating mode 250 the time t1 is 100 s.

The second heating unit 120 is controlled to the second target operating temperature T2 404 until time t3 406. In the first heating mode 250 the time t3 is 170 seconds. At time t3 the second heating unit 120 is controlled to increase its temperature to a third target operating temperature T4 409.

In the first heating mode 250 the third target operating temperature T4 is less than 240 deg C. In the first heating mode 250 the third target operating temperature T4 is less than 230 deg C. In the first heating mode 250 the third target operating temperature T4 is 220 deg C.

In the first heating mode 250 t3>t1 and T4>T2.

The second heating unit 120 is controlled to the third target operating temperature T4 409 until the time t2 408. In the first heating mode 250 the time t2 is 225 seconds.

At time t2 the second heating unit 120 is controlled to reduce its temperature to a second heating unit step-down temperature T3 410. In the first heating mode 250 the time t2 is more than 30 seconds before the end 306 of the session 302, more specifically 35 seconds before the end 306 of the session.

In the first heating mode 250 the second heating unit step-down temperature 410 is less than 220 deg C, more specifically less than 210 deg C, more specifically 200 deg C.

In the first heating mode 250 t2>t1. In the first heating mode T3>T2. In the first heating mode 250 T3<T5. In the first heating mode t3<t4<t2.

The second heating unit 120 is controlled to maintain its temperature at the second unit step-down temperature T3 until the end of the session 306.

In addition to being illustrated in FIG. 3, the first heating mode 250 is specified in table 1. Table 1 shows cumulative temperatures for the first and second heating units up to a specified time. For each heating unit, each temperature shown in the table is that to which the particular heating unit is controlled up to the time specified in the corresponding time value. For example, in the first heating mode the first heating unit is controlled to 240 deg C from 0 to 185 s and to 210 deg C from 185 to 260 s. The final time entry indicates the end of the session of use.

TABLE 1
First Heating Mode

| | |
|---|---|
| First Heating Unit | Second Heating Unit |

| Time since | Temperature | Time since | Temperature |
|---|---|---|---|
| session start | (deg C) | session start | (deg C) |
| 185 | 240 | 100 | 0 |
| 260 | 210 | 170 | 150 |
| | | 225 | 220 |
| | | 260 | 200 |

FIG. 4 depicts third and fourth temperature profiles 600, 700 which form a second heating mode 500. The second heating mode 500 is a boost heating mode. In comparison to the base heating mode, in the boost heating mode the aerosol provision device is configured to generate aerosol at a higher rate for shorter session of use 502. This is achieved by controlling the first and second heating units 110 120 to generally higher temperatures and having both heating units 110 120 heating at the same time for a greater proportion of the session of use 502. In use the user selects which of the first and second heating modes 250 500 to use for a particular article 200, for example by providing an input via buttons.

The third temperature profile 600 shows the temperatures to which the first heating unit 110 is controlled across the session of use 502. The session of use 502 begins when the device is activated 504 and the controller controls the device to supply energy to at least the first heating unit 110.

The end 506 of the session of use 502 occurs when the controller instructs elements in the device to stop supplying energy to all heating units present in the aerosol-generating device, at time tboost. The time tboost<tbase. In the present example the time tboost is 195 seconds.

At the beginning of the session of use 502 the temperature of the first heating unit 110 is controlled to a first target operating temperature T1 608.

T1 is the first unit maximum operating temperature, which is the maximum temperature to which the first heating unit 110 is controlled during the session of use 502. In the second heating mode 500 T1 is 260 deg C.

The first heating unit 110 is controlled to maintain its temperature at the first target operating temperature T1 608 until time t4 610. In the second heating mode 500 the time t4 is 30 seconds.

At time t4 the first heating unit 110 is controlled to reduce its temperature to a first heating unit step-down temperature T5 612. In the second heating mode 500 T5 is 210 deg C.

The first heating unit 110 is controlled to maintain its temperature to the first heating unit step-down temperature T5 until time t5 614. In the second heating mode 500 the time t5 is 135 seconds.

At time t5 the first heating unit 110 is controlled to reduce its temperature to an additional first heating unit step-down temperature T6 616. In the second heating mode T6 is 210 deg C.

The first heating unit 110 is controlled to maintain its temperature at the additional first unit step-down temperature T6 until the end of the session 506. The end of the session 506 occurs at time tboost.

The fourth temperature profile 500 shows the temperatures to which the second heating unit 120 is controlled across the aerosol generation session 502 in the second heating mode 500.

In the second temperature profile 400 the second heating unit 120 is controlled to an initial second unit temperature T0. During this time, the controller does not supply energy to the second heating unit 120, such that T0 is an unheated temperature. Nevertheless, the temperature at the second induction heating element will likely rise somewhat due to thermal “bleed”—conduction, convection and/or radiation of thermal energy from the first heating element 114 to the second heating element 124.

At time t1 702, the controller begins to supply power to the second heating unit 120. The second heating unit 120 is controlled to a second target operating temperature T2 704. In the second heating mode 500 the second target operating temperature T2 is 160 deg C. In the second heating mode 500 the time t1 is 25 s.

The second heating unit 120 is controlled to the second target operating temperature T2 704 until time t3 706. In the second heating mode 500 the time t3 is 80 seconds. At time t3 the second heating unit 120 is controlled to increase its temperature to a third target operating temperature T4 708. In the second heating mode 500 the third target operating temperature T4 is less than 260 deg C. In the second heating mode 500 the third target operating temperature T4 is 250 deg C.

The second heating unit 120 is controlled to the third target operating temperature T4 708 until the time t2 710. In the second heating mode 500 the time t2 is 225 seconds. At time t2 the second heating unit 120 is controlled to reduce its temperature to a second heating unit step-down temperature T3 712. In the second heating mode 500 the second heating unit step-down temperature 410 is 200 deg C.

The second heating unit 120 is controlled to maintain its temperature at the second unit step-down temperature T3 until the end of the session 506.

In the second heating mode 500, the third target operating temperature T4 is equal to first heating unit step-down temperature T5. In the second heating mode 500, the time t2 710 is equal to the time t5 614. In the second heating mode 500, the second heating unit step-down temperature T3 712 is equal to the additional first heating unit step-down temperature T6 616.

In addition to being illustrated in FIG. 5, the second heating mode 500 is specified in Table 2. Table 2 shows cumulative temperatures for the first and second heating units up to a specified time. As in Table 1, for each heating unit, the temperature shown is that to which the particular heating unit is controlled up to the time specified in the corresponding time column.

TABLE 2
Second Heating Mode

| First Heating Unit | | Second Heating Unit | |
|---|---|---|---|
| Time since | First heating unit | Time since | First heating unit |
| session start | target temperature | session start | target temperature |
| 30 | 260 | 25 | 0 |
| 135 | 250 | 80 | 160 |
| 195 | 210 | 135 | 250 |
| | | 195 | 210 |

An exemplary device was tested according to the first heating mode 250 in comparison to a device operated according to a comparative example heating mode. The comparative example heating mode is summarised in Table 3 below. As before, Table 3 shows cumulative temperatures of the first and second heating units up to a specified time.

TABLE 3
Comparative example heating mode

| | First heating unit | | Second heating unit |
|---|---|---|---|
| Time | target temperature | Time | target temperature |
| 185 | 250 | 82 | 0 |
| 260 | 220 | 170 | 160 |
| | | 260 | 250 |

The devices operated under the first heating mode 250 and the comparative example heating mode were assessed for device body external temperature and for user sensory experience. In general, it is desirable to reduce device body external temperature as much as possible for user comfort. It is also desirable to improve or maintain user sensory experience.

In a test conducted at room temperature, the first heating mode 250 was found to significantly reduce the external temperature of the device body in comparison to the comparative example heating mode. The comparative example heating mode was found to be unacceptable in terms of external temperature of the device body (with temperatures of 55 deg C often being exceeded). In particular, it was found that towards the end of a session of use the external temperature of the device body became too high under the first comparative example.

Without wishing to be bound by theory, the reduction in external device temperature in the first heating mode 250 may be due to some target temperatures (e.g. first target operating temperature T1, second target operating temperature T2, third target operating temperature T4 and first heating unit step down temperature T5) being reduced in the first heating mode 250, the second heating unit temperature being stepped down (to the second heating unit step-down temperature T3) in the first heating mode 250 and/or the second heating unit beginning heating later in the session in the first heating mode 250.

Sensory experience for devices operating under the first heating mode 250 and the comparative example heating mode was assessed by a panel of users under a sequential monadic testing methodology. The panel included 15 users with 2 replicates, providing 30 data points.

The results of the user sensory experience are summarised below in Table 4 for several user sensory attributes. The First Heating Mode column shows the performance of the first heating mode in comparison to the comparative example heating mode, with “lower” indicating a lower performance score and “NSD” indicating no significant difference in the result. “FP” indicates the result for the first two puffs in a session of use while “D” shows the result for the remaining, later puffs in the session of use.

TABLE 4

| | | First Heating |
|---|---|---|
| Attribute Group | Sensory Attribute | Mode 250 |
| Immediacy | FP Draw Resistance | NSD |
| | FP Aerosol Warmth | Lower |
| | FP Visible Aerosol | NSD |
| | FP Impact | NSD |
| | FP Irritation | NSD |
| | FP Flavor Amplitude | NSD |
| Overall | D Draw Resistance | NSD |
| Experience | D Aerosol Warmth | NSD |
| | D Visible Aerosol | NSD |
| | D Impact | NSD |
| | D Irritation | NSD |
| | D Tobacco Taste | NSD |
| | Intensity | |
| | D Flavor Amplitude | NSD |
| | D Overall Flavor | NSD |
| | Intensity | |
| | D Off Taste | NSD |
| | D Flavor Consistency | NSD |

The results in Table 4 show that, surprisingly (due to the significant reduction in device body temperature for the first heating mode in comparison to the comparative example heating mode) devices operating under the first heating mode 250 and the first comparative heating mode give very similar user sensory experience.

In particular, it was surprising that controlling the second heating unit to reduce its temperature to a second unit step-down temperature T3 at the time t2 after the start of the aerosol generation session (as in the first heating mode 250 and the second heating mode 500 but not in the comparative example heating mode) did not adversely affect sensory experience in the later puffs of the user sensory test (“D”). Reducing second heating unit temperature in this way has been found to significantly reduce device external temperature, since device external temperature in the session generally peaks at the end of the session.

Additionally, it was surprising that controlling the second heating unit to begin heating to the second target operating temperature T2 at the time t1, with t1>85 seconds (as in the first heating mode 250 but not in the comparative example heating mode, where the second heating unit began heating at 82s) did not adversely affect sensory experience in the later puffs of the user sensory test (“D”). Beginning heating at the second heating unit later in the session in this way has been found to significantly reduce device external temperature, since heating for longer at both heating units has a cumulative effect on device external temperature.

The various embodiments described herein are presented only to assist in understanding and teaching the claimed features. These embodiments are provided as a representative sample of embodiments only, and are not exhaustive and/or exclusive. It is to be understood that advantages, embodiments, examples, functions, features, structures, and/or other aspects described herein are not to be considered limitations on the scope of the invention as defined by the claims or limitations on equivalents to the claims, and that other embodiments may be utilized and modifications may be made without departing from the scope of the claimed invention. Various embodiments of the invention may suitably comprise, consist of, or consist essentially of, appropriate combinations of the disclosed elements, components, features, parts, steps, means, etc, other than those specifically described herein. In addition, this disclosure may include other inventions not presently claimed, but which may be claimed in future.

1. An aerosol provision system comprising an article and an aerosol provision device,
wherein the article comprises a heating element and an aerosol generating material, wherein the heating element is a susceptor;
wherein the aerosol provision device is configured to receive at least a portion of the article, the aerosol provision device comprising:
a first heating unit arranged to heat the aerosol generating material to form aerosol in use, wherein the first heating unit is an induction heating unit comprising an inductor coil, the inductor coil configured to heat the susceptor of the article;
a second heating unit arranged to heat the aerosol generating material to form aerosol in use; and
a controller configured to control the first and second heating units during an aerosol generation session according to a heating mode, wherein during the heating mode the controller is configured to:
control the first heating unit to begin heating to a first target operating temperature T1 at the beginning of the session;
control the second heating unit to begin heating to a second target operating temperature T2 at a time t1 after the start of the aerosol generation session,
control the second heating unit to heat to a third target operating temperature T4 at time t3 after the start of the aerosol generation session, wherein t3>t1 and T4>T2; and
control the first heating unit to reduce its temperature to a first heating unit step-down temperature T5 at time t4 after the start of the aerosol generation session,
wherein t4<t3.

2. An aerosol provision device according to claim 1, wherein during the heating mode the controller is configured to control the second heating unit to reduce its temperature to a second heating unit step-down temperature T3 at time t2 after the start of the aerosol generation session.

3. An aerosol provision device according to claim 1, wherein during the heating mode the controller is configured to:
control the first heating unit to heat to a first unit maximum operating temperature during the aerosol generation session; and
control the second heating unit to heat to a second unit maximum operating temperature during the aerosol generation session,
wherein the first unit maximum operating temperature is greater than the second unit maximum operating temperature.

4. An aerosol provision device according to claim 1, wherein the first heating unit and the second heating unit are configured to heat different portions of the aerosol generating material.

5. An aerosol provision device according to claim 1, wherein the first heating unit and the second heating unit are spatially separated.

6. An aerosol provision device according to claim 1, wherein the aerosol provision device has a mouth end, wherein the first heating unit is arranged closer to the mouth end than the second heating unit.

7. An aerosol provision device according to claim 1, wherein the first and second heating units comprise induction heating units.

8. An aerosol provision device according to claim 1, wherein the heating mode is a base heating mode and the controller is further configured to heat according to a boost heating mode, wherein in the boost heating mode the device is configured to generate aerosol at a higher rate for a shorter duration than in the base heating mode.

9. An aerosol provision device according to claim 1, wherein during the heating mode the controller is configured to control the second heating unit not to heat until the time t1.

10. An aerosol provision device according to claim 1, wherein t1>90 seconds.

11. An aerosol provision device according to claim 1, wherein t1>95 seconds, optionally t1 is substantially 100 s.

12. An aerosol provision device according to claim 1, wherein the second heating unit is a resistive heating unit.
